(19) United States
(12) Patent Application Publication
(10) Pub. No.: US 2019/0369545 A1
(43) Pub. Date: Dec. 5, 2019

(54) DRIVE TRANSMISSION DEVICE AND IMAGE FORMING APPARATUS

(71) Applicant: CANON KABUSHIKI KAISHA, Tokyo (JP)

(72) Inventors: Hideki Kotsuka, Yokohama-shi (JP); Tomokazu Morita, Mishima-shi (JP)

(21) Appl. No.: 16/420,503

(22) Filed: May 23, 2019

(30) Foreign Application Priority Data
May 30, 2018 (JP) 2018-103586
Jan. 7, 2019 (JP) 2019-000427

(51) Int. Cl. G03G 15/00; F16H 55/08; F16H 1/08; F16H 1/20

(52) U.S. Cl. CPC G03G 15/757; F16H 1/20; F16H 1/08; F16H 55/0806

(57) ABSTRACT

A drive transmission device first and second gears. Each tooth of the first gear includes, between tooth top and bottom, one tooth surface and the other tooth surface on an opposite side. Each tooth of the second gear includes, between tooth top and bottom thereof, one tooth surface and the other tooth surface of the second gear on an opposite side. The one surfaces of the first and second gears engage to each other, and the other surfaces of the first and second gears are not. The one surface extends along respective involute curves. For at least one of the first gear and the second gear, the other surface extends from a tooth top side to a tooth bottom side along a linear line inside a plane which is symmetrical with the one surface with respect to a line connecting the tooth top and the tooth bottom.

### FIELD OF THE INVENTION AND RELATED ART

The present invention relates to a drive transmission apparatus for transmitting a driving force (drive) to a rotatable member via a plurality of gears and an image forming apparatus provided with the same.

An image forming apparatus such as a printer, a copying machine, or a facsimile machine is provided with a photosensitive drum including a photosensitive layer capable of forming an electrostatic latent image by an exposure unit, and the photosensitive drum carries a toner image formed by a developing device. The photosensitive drum is rotated by receiving the driving force from a driving source, and the toner is deposited to the electrostatic latent image by the developing device. Thereafter, the toner deposited on the photosensitive drum is transferred onto a recording material by a transfer device. However, there are not a few toner particles remaining on the photosensitive drum without being transferred onto the recording material by the transfer device, and therefore, a toner removing unit is provided to remove the residual toner from the photosensitive drum.

The toner removing portion is roughly classified into two types of toner removing portions. The first toner removing type has a cleaning blade, in which the cleaning blade is contacted to the rotating photosensitive drum in a counter direction to scrape the toner off the photosensitive drum. The other type the removing portion is generally called cleaner-less structures. The toner remaining on the photosensitive drum is collected into the developing portion by electrostatic attraction simultaneously with the toner depositing operation to the photosensitive drum by the developing portion. That is, there is no cleaning blade provided.

Here, focusing on the load torque when rotating the photosensitive drum, there are the following differences between the above-mentioned two types. In the case of the structure with the cleaning blade, the load torque is large because the friction force at the blade contact portion is large, and in the case of the cleaner-less structure, the load torque is small because the friction force hardly exists. However, when the load torque is small, uneven rotation of the photosensitive drum is likely to occur.

For example, in the case that the alignment of the gears meshing with each other is slightly broken, if the load torque is large to some extent, the gear teeth will be partly collapsed, and therefore, A contact area between meshing teeth can be assured. However, when the load torque is small, the gear tooth surface is not collapsed, and therefore, the contact area between the meshing tooth surfaces becomes very small, and the meshing ratio decreases. For this reason, when the load torque is small, uneven rotation of the photosensitive drum is likely to occur, as previously mentioned.

That is, the cleaner-less structure has advantages in terms of resource saving, downsizing and energy saving, as compared with a structure including a cleaning blade, in that remaining toner can be reused, no need for space to collect and store residual toner, and the driving torque is small. However, because the cleaner-less structure has a small load torque, uneven rotation is likely to occur, and there is a problem that image defects such as banding occur.

Conventionally, as a structure for eliminating the uneven rotation when the load torque is small, there is a structure in which the load torque is applied to the side surface of the photosensitive drum by a coil spring (Japanese Patent Application Laid-Open No. 6-124054). In addition, there is also a structure in which a frictional force is applied by a thrust force provided by a gear and the frictional force can be adjusted (Japanese Laid-open Patent Application No. 2004-156746).

In addition, as a structure for making the teeth of the gear easy to bend, the are proposed a structure in which the material of the teeth is soft (Japanese Laid-open Patent Application No. 2003-323077), a structure in which the tooth width of the gear is narrowed, and a structure in which holes are formed in the tooth portion H10-71194).

In addition, as a structure for making the gear teeth easy to bend, there is a structure (Japanese Patent Application Laid-Open No. H6-305224) provided with a portion which provides a spring effect on the gear teeth. More specifically, as shown in FIG. 13, a substantially rectangular cut-away portion 61a is provided on each side of a root of the tooth 61 so that the gear teeth 61 are movable in the circumferential direction with spring effect.

In addition, Japanese Utility Model Application Laid-Open No. S59-22459 discloses a gear device comprising a pair of gear wheels meshing with each other.

As shown in FIG. 17, in Japanese Utility Model Application Publication No. S59-122459, cut-away portions 63a and 65a are formed on tooth surfaces opposite to each other, for all the teeth 63 of one gear 62 and every other tooth 65 of the other gear 64. In addition, for the remaining teeth 66 of the other gear 64, an extending portion 66a projecting in the teeth thickness direction is provided on one tooth surface opposite to the opposite tooth surface of the teeth 65 including the cut-away portion 65a, and a cut-away portion 66b is formed in the portion.

However, while achieving energy saving and low cost, it was difficult to reduce the uneven rotation of the rotatable member, when the load torque of the rotatable member is small. In the structure in which load torque is forcibly applied, one advantage of the cleaner-less structure of energy saving is lost. Furthermore, the cost increases due to the addition of a mechanism that applies load torque.

In addition, in order to make the gear teeth easy to bend, the material of the gear may be the one such as polyester-based elastomer that is softer than polyacetal (POM) generally used for printer gear, but in this case the cost unavoidably increases. In addition, in the structure in which the gear tooth width is reduced, the meshing ratio is reduced. A possible structure is to make holes in the gear teeth, but it is necessary to make the hole diameter very small because the gear module for driving the photosensitive drum generally has small teeth of about 0.5. For this reason, in order to make a gear by molding, it is necessary to make a mold with thin projections, then mold strength is so low that it is not practical. In addition, a structure is conceivable in which approximately square cut-away portions are provided on both sides of the root of the tooth, but in such a case, the tooth surface is formed to the tooth bottom and the under surface is cut away in order to maintain good meshing. However, in such a case as well, it is necessary to make a mold including thin projections in order to make it by molding, and the mold strength is so low that it is not practical, again.

### SUMMARY OF THE INVENTION

According to an aspect of the present invention, there is provided a drive transmission device for transmitting a driving force to a rotatable member, said device comprising a first gear and; a second gear in meshing engagement with the first gear; wherein each tooth of said first gear includes, between a tooth top and a tooth bottom, one tooth surface and the other tooth surface on an opposite side of said one tooth surface, and each tooth of said second gear includes, between a tooth top of said second gear and a tooth bottom of said second gear, one tooth surface and the other tooth surface of said second gear on an opposite side of said one tooth surface of said second gear, wherein said one tooth surface of said first gear engages to said one tooth surface of said second gear, and the other tooth surface of said first gear is not engaged to the other tooth surface of said second gear, wherein said one tooth surface extend along respective involute curves, and wherein for at least one of said first gear and said second gear, the other tooth surface extends from a tooth top side to a tooth bottom side along a linear line inside a plane which is symmetrical with said one tooth surface with respect to a line connecting the tooth top and the tooth bottom.

Further features of the present invention will become apparent from the following description of exemplary embodiments with reference to the mounted drawings.

### BRIEF DESCRIPTION OF THE DRAWINGS

FIG. 1 is an illustration showing a gear shape according to Embodiment 1.

FIG. 2 is a schematic block illustration of an image forming apparatus according to Embodiment 1.

FIG. 3 is a top plan view illustrating a photosensitive drum drive transmission device according to Embodiment 1.

FIG. 4 is a rear view of the photosensitive drum drive transmission device according to Embodiment 1.

FIG. 5 is a schematic view of a meshing tester used to measure a rotation transmission error of a gear.

FIG. 6 is a view illustrating the results of measurement of the rotation transmission error and load torque in connection with misalignment of gears of a comparative example.

FIG. 7 is a view illustrating a result of measurement of a rotation transmission error relative to misalignment of a gear according to Embodiment 1 under a low load torque.

FIG. 8 is a view illustrating a contact area of meshing tooth surfaces under high load torque of the gear in the comparative example.

FIG. 9 is a view illustrating a contact area of meshing tooth surfaces under low load torque of a gear of a comparative example.

FIG. 10 is a view illustrating a contact area between tooth surfaces meshing with each other under low load torque of the gear according to Embodiment 1.

FIG. 11 is a view illustrating a gear shape according to Embodiment 2.

FIG. 12 is a view illustrating a gear shape according to Embodiment 3.

FIG. 13 is a view illustrating a conventional gear shape.

FIG. 14 is a schematic structure illustration of an image forming apparatus according to Embodiment 4.

FIG. 15 is a rear view illustrating a photosensitive drum and an intermediary transfer belt drive transmission device according to Embodiment 4.

FIG. 16 is an illustration showing a gear shape according to Embodiment 4.

FIG. 17 is a view illustrating a conventional gear shape.

### DESCRIPTION OF THE EMBODIMENTS

In the following, preferred embodiments of the present invention will be described in detail with reference to the accompanying drawings. However, the dimensions, materials, shapes, relative positions, and so on of components described in the following embodiments should be appropriately changed, depending on the structure of the apparatus to which the present invention is applied and on various conditions. Therefore, the scope of the present invention is not intended to be limited to only these examples unless specifically stated otherwise.

### Embodiment 1

A image forming apparatus provided with a drive transmission device according to Embodiment 1 will be described in detail with reference to the drawings. First, the image forming apparatus will be described, and then the drive transmission device will be described.

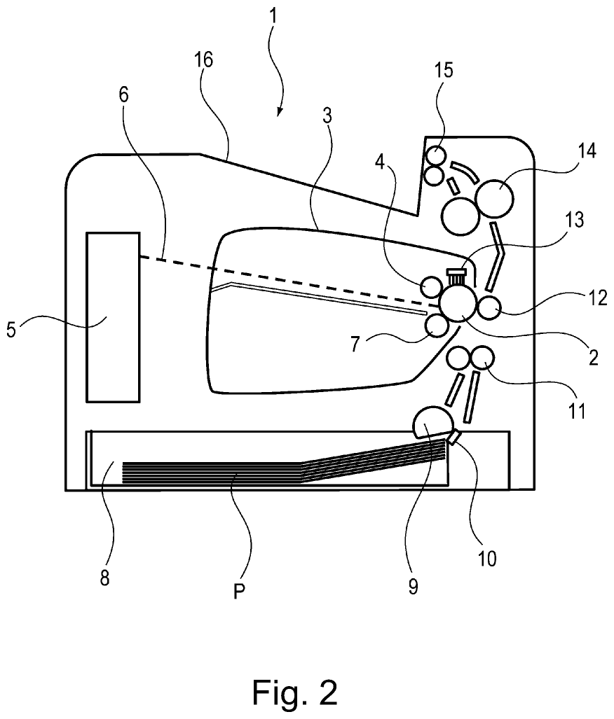

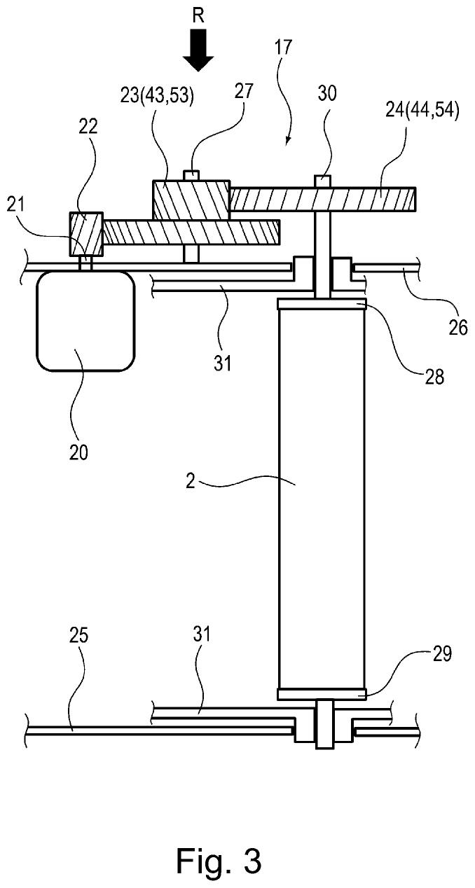

FIG. 2 is a schematic structure view of the image forming apparatus 1 according to this embodiment as viewed from the front side of the apparatus. In FIG. 2, reference numeral 2 depicts an image bearing member which is a photosensitive drum. The photosensitive drum 2 is rotatably supported by the process cartridge 3 containing a black developer (toner) at opposite ends thereof. In addition, the photosensitive drum 2, which is a rotatable member, receives a driving force from a rear end of the image forming apparatus 1 by the motor 20 and gears 22, 23, 24 shown in FIG. 3, and rotates counterclockwise in FIG. 2. The photosensitive drum 2 is a photosensitive member on the surface of which an organic photosensitive member layer as a photosensitive layer is applied. The surface of the photosensitive drum 2 is uniformly charged, by applying a charging bias to the charging roller 4. The charged photosensitive drum 2 is selectively exposed by a laser beam 6 emitted from a laser scanner unit 5 which is an exposure portion, so that an electrostatic latent image is formed. The electrostatic latent image formed on the photosensitive drum 2 receives the toner by the developing portion 7 to be developed into a toner image.

A recording sheet P as a recording material is stacked on a feeding cassette 8. The recording sheet P is fed by the feed roller 9 driven at a predetermined timing by drive motor and drive transmission portion not shown, and at the same time, the recording material is singled out by the frictional force of the separation pad 10, so that only one recording sheet P is fed. Thereafter, the recording sheet P passes through a pair of registration rollers 11 and is fed to a transfer position where the photosensitive drum 2 and the transfer roller 12 as a transfer portion contact with each other. At the transfer position, the toner image on the photosensitive drum 2 is transferred onto the recording sheet P, by the transfer roller 12 to which a predetermined bias is applied.

Here, the toner images on the photosensitive drum 2 are not entirely transferred onto the recording sheet P, and some toner remains on the photosensitive drum 2 as residual toner after transfer. The residual toner is stirred by the memory removing member 13 formed of a conductive brush or the like and uniformly dispersed. Thereafter, simultaneously with the toner adhesion operation to the photosensitive drum 2 by the developing portion 7, the residual toner is collected by the developing portion 7 by electrostatic attraction. This residual toner removing portion is generally called a cleaner-less portion.

Although a structure using a memory removing member made of a conductive brush or the like has been exemplified as cleaner without contact with a photosensitive drum and without a cleaning blade, the present invention is not limited to this example. A cleaner-less structure without a cleaning blade may be used without using a conductive brush. The residual toner remaining on the photosensitive drum after the transfer process is charged to the same negative polarity as the photosensitive drum by the electric discharge in the gap before a charging nip. The negatively charged residual toner will pass through the charging nip where the photosensitive drum and the charging roller face each other without adhering to the charging roller, due to the relationship of the potential difference (for example, the photosensitive drum surface potential=−700V, the charging roller potential=−1300V). The residual toner which has passed through the charging nip reaches the laser irradiation position at the surface of the photosensitive drum where the laser beam is irradiated. The amount of the residual toner is not so large as to block the laser beam in the exposed area, and therefore, the residual toner does not affect the process of forming an electrostatic latent image on the photosensitive drum. Of the toner which has passed the laser irradiation position, the toner in the non-exposed area (the photosensitive drum surface not having been received the laser irradiation) is collected by electrostatic force in the developing area.

On the other hand, among the toner which has passed the laser irradiation position, the toner of the exposed portion (the surface of the photosensitive drum subjected to laser irradiation is not collected electrostatically but continues to be present on the photosensitive drum. However, some toner may be collected by physical force due to the peripheral speed difference between the developing portion and the photosensitive drum. As described above, the toner remaining on the photosensitive drum without being transferred onto the recording sheet is generally collected in the developing portion. And, the toner collected in the developing portion is mixed with the toner remaining in the developing portion and is reused.

In addition, in order to allow the residual toner remaining on the photosensitive drum to pass through the charging nip without adhering to the charging roller, a optical charge removing member may be provided between the transfer roller and the charging roller in the rotational direction of the photosensitive drum. The light discharging member light-discharges the surface potential of the photosensitive drum after passing through the transfer nip to perform a stable discharge at the charging nip. The light discharging member is provided separately from the exposure portion, and is a post-transfer exposure portion which irradiates light to toner remaining on the photosensitive drum after the image transfer operation. By removing the potential of the photosensitive drum before charging with this light discharging member by the light-discharging, a uniform discharge operation can be performed during charging, so that it is possible to make the untransferred residual toner uniformly negative. As a result, the transfer residual toner passes through the charging nip.

Or, in order to allow the residual toner remaining on the photosensitive drum to pass through the charging nip without adhering to the charging roller, the charging roller may be driven to rotate with a predetermined circumferential speed difference relative to the photosensitive drum. As described above, although most toner becomes negative by the discharging, some small amount of the toner which cannot become negative may remain, and such toner may be deposited onto the charging roller at the charging nip. In view of this, the charging roller and the photosensitive drum are driven to rotate with a predetermined circumferential speed difference by which the rubbing between the photosensitive drum and the charging roller makes it possible to make such toner negative. By this, the deposition of toner a charging roller can be reduced.

As described above, instead of using a conductive brush, a cleaner-less structure without a cleaning blade may be employed.

The recording sheet P to which the toner image is transferred is fed to the fixing roller pair 14 as a fixing portion, and the toner image is melted and fixed on the recording sheet P by heat and pressure, whereby a image print is provided. The recording sheet P fed by the fixing roller pair 14 passes through a discharge roller pair 15 and is discharged and stacked on a discharge tray 16.

FIG. 3 is a view illustrating the drive transmission device 17 for rotationally driving the photosensitive drum 2 which is a rotatable member, as viewed from the top of the image forming apparatus 1 in FIG. 2. As shown in FIG. 3, a drive transmission device 17 for transmitting the drive to the photosensitive drum 2 has a driving motor 20 as a drive source, a pinion gear 22, a transmission gear 23 as a first gear, and a drum gear 24 as a second gear. The driving motor 20 functioning as a driving source is fastened to a rear side plate 26 of the main assembly of the apparatus by screws (not shown). The pinion gear 22 is press-fitted and fixed to a motor shaft 21 which is an output shaft of the driving motor 20. The gear shaft 27 is mounted to the rear side plate 26 by a clamping portion. The transmission gear 23 is rotatably supported by the gear shaft 27. The photosensitive drum 2 which is a rotatable member has a hollow structure, and flanges 28 and 29 made of resin are press-fitted and fixed to each of opposite ends thereof. The drum shaft 30, which is a rotatable shaft, penetrates the inside of the photosensitive drum 2 and is fixed and supported by the flanges 28, 29. That is, the drum shaft 30 and the photosensitive drum 2 are rotatable integrally. The drum gear 24, which is a rotatable gear, is press-fitted and fixed to one end of the drum shaft 30, which is a rotatable shaft. The frame 31 of the process cartridge is positioned by being inserted into holes provided in the front side plate 25 forming the main assembly frame of the image forming apparatus and the rear side plate 26 facing the front side plate 25, and is supported by a pressing portion not shown. There is. The drum shaft 30 is rotatably supported by the frame 31 of the process cartridge, and a drum gear 24 is mounted by a parallel pin (not shown) to the end of the rear surface side (rear side plate 26 side). Therefore, when the drum gear 24 rotates, the photosensitive drum 2 rotates by way of the drum shaft 30.

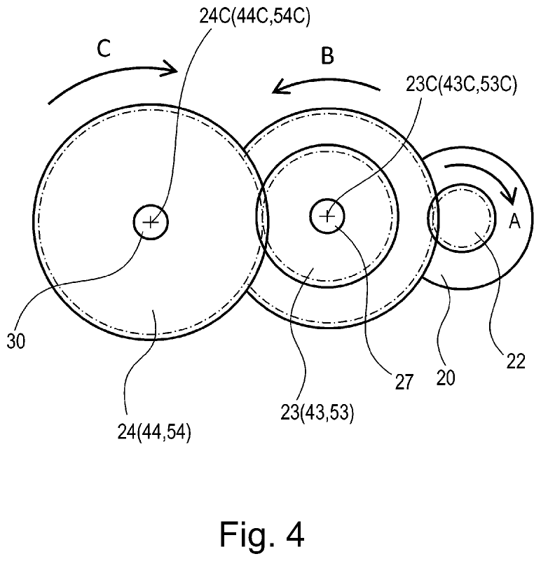

FIG. 4 is a view illustrating a rotational direction of the drive transmission device for rotationally driving the photosensitive drum 2, as viewed from the back side (the direction of arrow R in FIG. 3) of the image forming apparatus in FIG. 2. The pinion gear 22 is rotated by the driving motor 20 in the direction of arrow A. The transmission gear 23 is in meshing engagement with the pinion gear 22. When the pinion gear 22 rotates in the arrow A direction, the transmission gear 23 rotates in the arrow B direction. Here, the transmission gear 23 is a step gear including a large gear meshing with the pinion gear 22 and a small gear smaller in diameter than the large gear and meshing with the drum gear 24, and the transmission gear 23 has a reduction function. The drum gear 24 is in meshing engagement with the transmission gear 23. When the transmission gear 23 rotates in the arrow B direction, the drum gear 24 rotates in the arrow C direction.

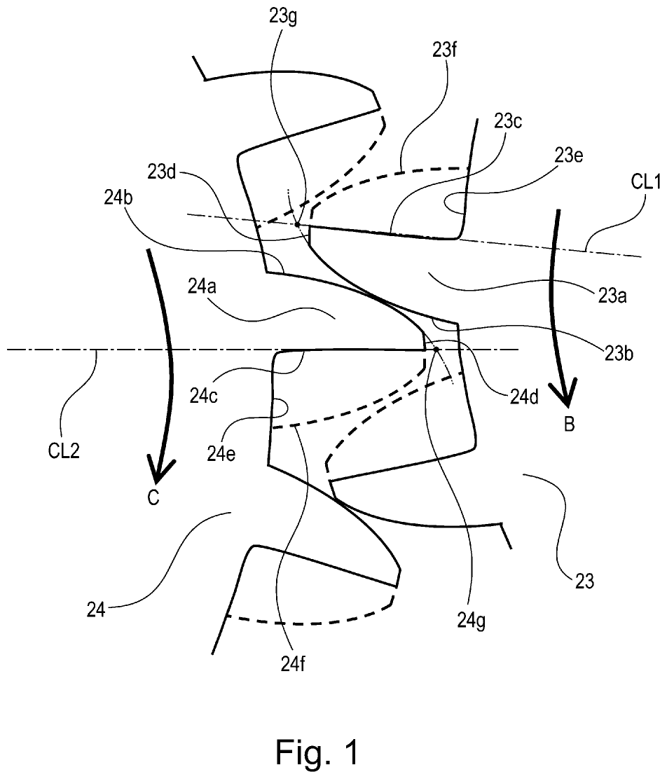

All the three gears mentioned above are the helical gears with involute flanks, and it has a module of 0.5 and is made of polyacetal (POM). Here, the involute tooth flank of the gear is a tooth flank formed along the involute curve. The involute curve is a curve (a curved surface indicated by a solid line in FIG. 1 and an imaginary curved surface indicated by a dotted line) formed from a base circle (a circle indicated by a chain line shown in FIG. 4). That is, the involute curve is a plane curve having a normal line always in contact with one constant circle (base circle), and it is a curve drawn by an end (free end) of a string wound around the base circle when the string is unwound without slack. Here, the base circle is the circle on which the involute curve is based, and is determined by a size of a reference circle, which is a standard of the gear size, and a pressure angle (tooth inclination) of the gear.

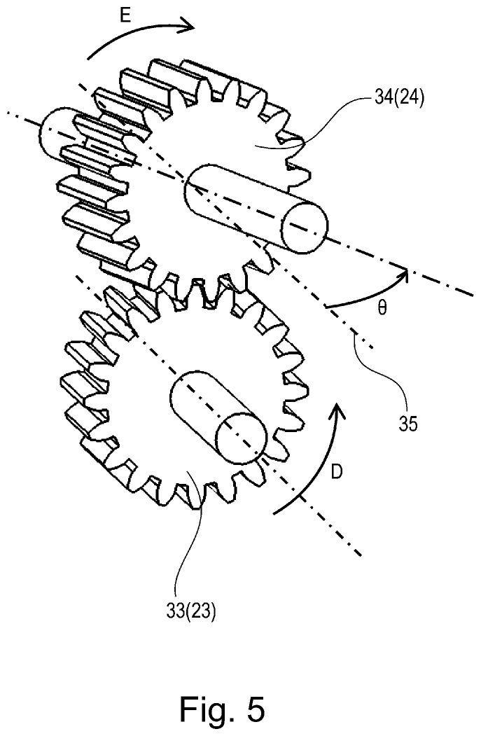

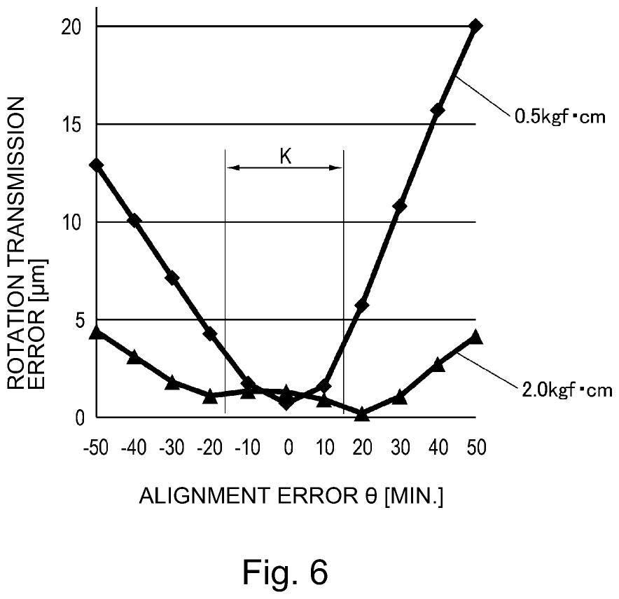

In this embodiment, as described above, the cleaner-less portion is employed, and therefore, when the photosensitive drum 2 rotates, its frictional resistance is light, and its load torque is as light as about 0.5 kgf·cm. On the other hand, in the structure including the cleaning blade, the load torque is generally as great as 2.0 kgf·cm or more. Here, the explanation will be made as to the difference in rotation unevenness due to load torque and the cause thereof. FIG. 5 is a schematic view of a testing machine used to measure rotational unevenness. The input gear 33 corresponding to the transmission gear 23 is driven by a driving force transmitted from a drive source (not shown) to rotate in the direction of arrow D. A driven gear 34, which corresponds to the drum gear 24, is in meshing engagement with the input gear 33, and the input gear 33 rotates in the direction of arrow D so that the driven gear 34 rotates in the direction of arrow E. On the driven gear 34 side, the load torque can be varied by a load portion (not shown). In addition, an axis 35 of the driven gear 34 can be inclined in a direction of an arrow θ, and the alignment with the input gear 33 can be deviated. FIG. 6 shows the relationship between the misalignment θ with respect to each load torque and the rotation transmission error when the gears of the comparative example are used. As shown in FIG. 5, in the gear of the comparative example, the tooth shapes of the input gear 33 and the driven gear 34 are formed such that the tooth surface on the meshing side and the tooth surface on the non-meshing side all follow the involute curve. In the gear meshing in this comparative example, when the load torque is the first load torque (here, 2.0 kgf·cm), the rotation transmission error does not change significantly even if the alignment is deviated. However, when the load torque is a second load torque (0.5 kgf·cm in this case) smaller than the first load torque, the rotation transmission error is greatly deteriorated if the alignment is even slightly deviated. Alignment deviation range K within good rotational transmission error in the second load torque is very narrow than in the first load torque.

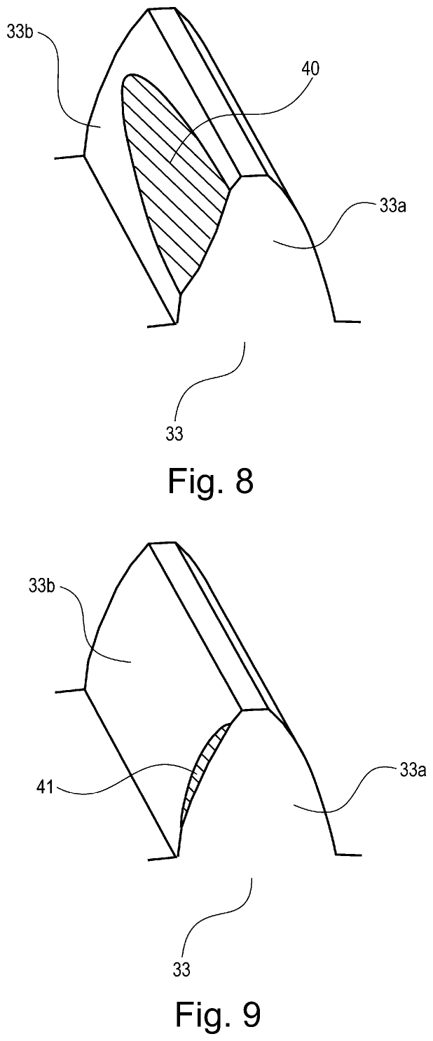

Next, the reason why the rotation transmission error is greatly deteriorated by a slight deviation of the alignment when the load torque is a second load torque that is smaller than the first load torque will be described. FIG. 8 is a enlarged view of the teeth 33a of the input gear 33 at the meshing portion in FIG. 5 when the load torque is the first load torque which is greater than the second load torque and the alignment is deviated. The load torque is the first load torque that is larger than the second load torque, and therefore, the tooth surface 33b on the meshing side of the teeth 33a of the input gear 33 is collapsed by the driven gear 34, so that the area of the meshing contact portion 40 is large. On the other hand, FIG. 9 is a enlarged view of the teeth 33a of the input gear 33 at the meshing portion in FIG. 5, when the load torque is a second load torque smaller than the first load torque and the alignment is deviated. The load torque is a second load torque smaller than the first load torque, and therefore, the degree to which the tooth surface 33b on the meshing side of the teeth 33a of the input gear 33 is collapsed by the driven gear 34 is smaller than that in the case of the first load torque, and the area of the meshing contact 41 is relatively small. The above is the explanation as to the fact that the rotation unevenness is different depending on the load torque, and when the load torque is the first load torque larger than the second load torque, the area of the meshing contact portion can be made large, and therefore, the meshing ratio is kept high and the rotation unevenness is small. On the other hand, when the load torque is a second load torque smaller than the first load torque, the area of the meshing tooth width is smaller than that in the case of the first load torque, and therefore, the meshing ratio decreases, and the rotation unevenness of the gear meshing cycle is deteriorated.

When the image forming apparatus is actually manufactured, it is difficult to completely eliminate the misalignment between the meshing gears, and when assembling is carried out without using a jig, the deviation of about ±30 minutes occurs. The deviation of ±30 minute in the alignment between the meshing gears is attributable to a deviation, in the tolerance range, of the variation in axis distance or axis inclination due to the terror in fitting between the gear and the shaft for fitting the gear, and/or displacement between the shaft for fitting the gear and a member such as a side plate for supporting the shaft. As described above, what has been described by exemplifying the comparative example has conventionally been the cause of the occurrence of image defects such as banding of the gear meshing cycle due to uneven rotation when employing a cleaner-less portion with a small load torque. Here, the jig for measuring the misalignment between the gears has two shafts, and the gears are mounted to the respective shafts. And, by shifting the alignment of one axis with respect to the other axis, the misalignment between the gears mounted to the two axes is measured.

In this embodiment, the shape of the teeth of at least one of the plurality of gears for transmitting the drive to the photosensitive drum, which is a rotatable member, is formed as shown in FIG. 1. FIG. 1 is a view illustrating the shapes of the transmission gear 23 and the teeth of the drum gear 24. As mentioned above, the drive transmission device 17 for transmitting the drive to the photosensitive drum, which is a rotatable member, has the driving motor 20, the pinion gear 22, the transmission gear 23, and the drum gear 24 (FIG. 3). FIG. 1 is a enlarged view of the major parts of a transmission gear 23 which is a first gear and a drum gear 24 which is a second gear meshing with the transmission gear 23 in the drive transmission device.

As shown in FIG. 1, each of the teeth 23a of the transmission gear 23 which is the first gear has one tooth surface 23b on the meshing side and the other tooth surface 23c on the opposite side to the tooth surface 23b, that is, on the non-meshing side, between the top 23d and the bottom 23e. Here, the one tooth surface 23b is a tooth surface formed along the involute curve (solid line in FIG. 1) from the tooth top end 23d to the tooth bottom end 23e. The other tooth surface 23c is a surface having a shape which is cut out inward from the involute curve (broken line in FIG. 1), extending from the tooth top end 23d to the tooth bottom end 23e. The other tooth surface 23c is a surface passing through the straight line CL1 from the tooth top end 23d to the tooth bottom 23e, the surface being inside the surface 23f which is plane-symmetrical to the one tooth surface 23c with respect to the straight line (plane) CL1 (imaginary plane shown by a dotted line in FIG. 1). Here, the straight line CL1 is a straight line passing from the rotation center of the transmission gear 23 (23C shown in FIG. 4) to the designed tooth top end 23g, when designing the involute gear of the tooth 23a. The straight line CL1 is a reference line, with respect to which the virtual surface (virtual surface indicated by a dotted line in FIG. 1) 23f and the one tooth surface 23b indicated by a solid line on the opposite side are in line (plane) symmetry.

The teeth 24a of the drum gear 24, which is the second gear meshing with the transmission gear 23, are also formed similarly to the teeth 23a of the transmission gear 23. Each of the teeth 24a of the drum gear 24, which is the second gear, has one tooth surface 24b on the meshing side and the other tooth surface 24c on the opposite side to the tooth surface 24b on the non-meshing side, between the top 24d and the bottom 24e. Here, the one tooth surface 24b is a tooth surface defined by a involute curve from the tooth top end 24d to the tooth bottom end 24e. The other tooth surface 24c is a surface having a shape which is cut inward from the involute curve from the tooth top end 24d to the tooth bottom 24e. The other tooth surface 24c is a surface passing through the straight line CL2 from the tooth top end 24d to the tooth bottom 24e, the surface being provided on the inner side than a line symmetrical surface (an imaginary surface shown by a dotted line in FIG. 1) 24f of the one tooth surface 24b with reference to the straight line CL2. Here, the straight line CL2 is a straight line passing from the rotation center of the drum gear 24 (24C shown in FIG. 4) to the designed tooth top end 24g, when designing the involute gear of the teeth 24a. The straight line CL2 is a reference line, with respect to which, a virtual surface (virtual surface shown by a dotted line in FIG. 1) 24f on the opposite side to the one tooth surface 23b is symmetrical with the one tooth surface 24b shown by a solid line in FIG. 1.

The teeth 23a of the transmission gear 23 and the teeth 24a of the drum gear 24 are engaged with each other at tooth flanks 23b and tooth flanks 24b defined along involute curves, by which drive transmission is performed. In the gear of the comparative example, the non-engagement-side tooth surface not used for engagement also had a tooth surface defined by the involute curve. However, the non-engagement-side tooth surfaces 23c and 24c which are not used for the meshing in this embodiment are shaped such that they are cut to the straight lines CL1 and CL2 which are the centers in the tooth thickness direction in the range from the tooth top end to the tooth base. By this, the teeth 23a and 24a of this embodiment are less rigid than the teeth of the gear of the comparative example.

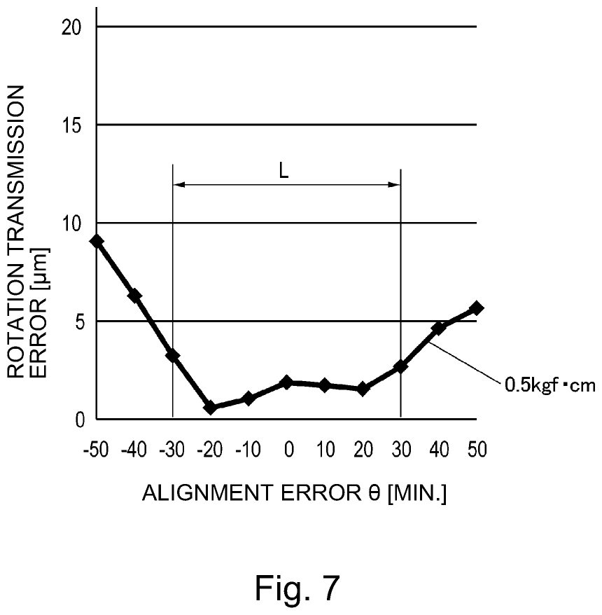

FIG. 7 is an illustration showing a relationship between the alignment deviation θ and the rotation transmission error, when the second load torque is smaller than the first load torque, in the case that the transmission gear 23 and the drum gear 24 of this embodiment are used as the input gear 33 and the driven gear 34 in FIG. 5. Here, as the second load torque, 0.5 kgf·cm is shown. As compared with the alignment deviation range K which is good in the comparative example shown in FIG. 6, the range L of the gear of this embodiment is larger.

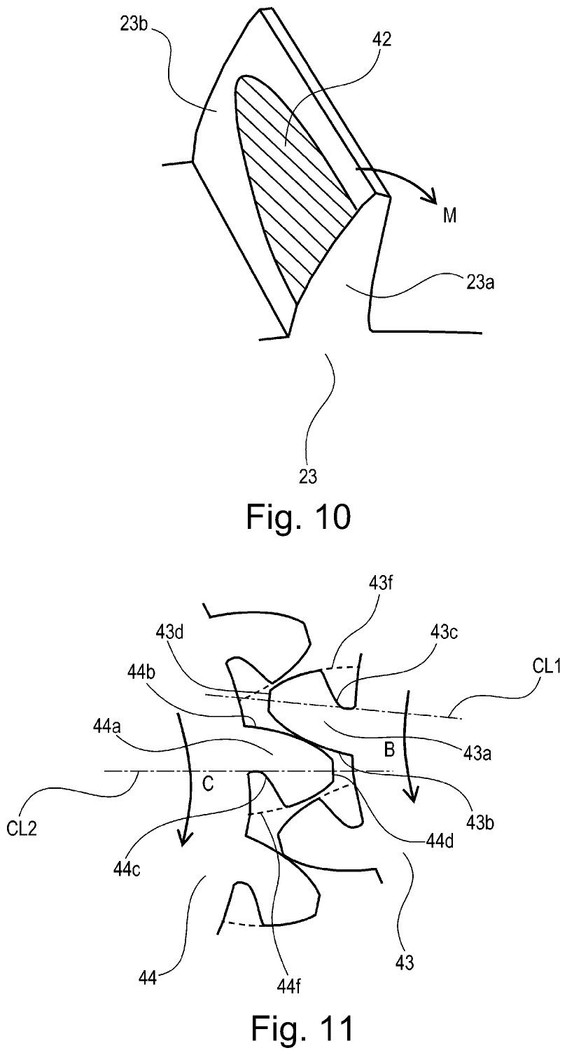

Next, it will be explained why the alignment deviation range L in which the rotation transmission error is good is larger in this embodiment than in the comparative example. FIG. 10 is an enlarged view of the tooth 23a of the transmission gear 23 corresponding to the input gear at the meshing portion in FIG. 5 when the load torque is smaller than the first load torque and is the second load torque, and the alignment is deviated. Although the load torque is a second load torque smaller than the first load torque, the teeth 23a of the transmission gear 23 are less rigid than the teeth of the input gear of the comparative example. Therefore, even if the alignment is deviated, as shown in FIG. 5, in the teeth 23a of the transmission gear 23, the side that makes strong contact in the tooth width direction (the front side in FIG. 10) is flexes in the arrow M direction, as shown in FIG. 10. By this, the tooth surface 23b of the transmission gear 23 approaches to the inclination of the tooth surface of the drum gear 24 corresponding to the driven gear, and therefore, the area of the meshing contact 42 can be increased as compared to the case of the comparative example. Therefore, in this embodiment, the meshing tooth width can be made large even if the load torque is small, and therefore, the meshing ratio can be made large, and the range L in which the rotation transmission error is acceptable can be made large. Here, the rotation transmission error of 3.5 or less is an acceptable deviation range L, but depending on the structure, it is possible to select the rotation transmission error of 5 or less four an acceptable deviation range.

As described in the foregoing, in this embodiment, the tooth surface on the non-engagement side of the gear is cut out substantially to the extent of the center in the tooth thickness direction in the range from the free end to the bottom of the gear. By this, even if a cleaner-less portion with a small load torque is employed and a misalignment of about ±30 minutes occurs in the alignment of the gears meshing with each other, the rotation unevenness of the photosensitive drum can be suppressed to be small. Therefore, it is possible to obtain a image forming apparatus free from image defects such as banding of a gear meshing cycle.

In addition, in general, many gear modules for driving the photosensitive drums are as small as about 0.5 as in this embodiment, but the gear shape of this embodiment can be molded without lowering the mold strength as compared with the structure in which holes are formed in the teeth of the gear described in JP-A-10-171194.

In addition, in this embodiment, the material of the gear for driving the photosensitive drum is polyacetal (POM), but according to this embodiment, it is not necessary to select a soft material for the gear, such as polyester elastomer, in order to make the gear teeth easy to flex, and therefore, low cost can be accomplished.

As described above, according to this embodiment, the rotation unevenness of the photosensitive drum can be reduced.

### Embodiment 2

In the following, a image forming apparatus provided with a drive transmission device according to Embodiment 2 will be described in detail, referring to the drawings. Here, the schematic structure of the image forming apparatus is the same as that of Embodiment 1 described above, and therefore, the explanation thereof is omitted. In addition, the same members as those of Embodiment 1 are denoted by the same reference numerals, and the description thereof is omitted. In this embodiment, the gears corresponding to the transmission gear 23 and the drum gear 24 in Embodiment 1 are different only in the shape of the teeth, and the transmission gear 43 and the drum gear 44 will be described with different reference numerals.

FIG. 11 is a view illustrating the shapes of the transmission gear 43 and the tooth of the drum gear 44, in this embodiment. As shown in FIG. 11, each of the teeth 43a of the transmission gear 43, which is the first gear, as one tooth surface 43b on the meshing side and the other tooth surface 43c on the opposite side to the tooth surface 43b, that is, on the non-meshing side. The one tooth surface 43b is formed in the range from the tooth top end 43d to the tooth bottom 43e in the same manner as the tooth surface 33b in Embodiment 1 described above. The other tooth surface 43c has a shape in which the tooth bottom side is cut-away inwardly of the line symmetrical tooth surface of the one tooth surface 43c with reference to the straight line CL1, except for the tooth top end portion. Here, the straight line CL1 is a straight line passing from the rotation center of the transmission gear 43 (43C shown in FIG. 4) to the top end of the tooth 43a. The straight line CL1 is a reference line, with respect to which a virtual surface (virtual surface shown by a dotted line in FIG. 11) 43f on the opposite side to the one tooth surface 43b is symmetrical with the one tooth surface 43b shown by a solid line in FIG. 11. Furthermore, specifically, in this embodiment, the other tooth surface 43c has a shape in which the tooth bottom side is cut off to the straight line CL1 (the center in the tooth thickness direction) except for the tooth top end side.

The teeth 44a of the drum gear 44, which is the second gear meshing with the transmission gear 43, are also formed similarly to the teeth 43a of the transmission gear 43. Each of the teeth 44a of the drum gear 44, which is the second gear, has one tooth surface 44b on the meshing side and the other tooth surface 44c on the opposite side to the tooth surface 44b, that is, on the non-meshing side. The one tooth surface 44b is formed in the same manner as the tooth surface 34b in Embodiment 1 described above in the range from the tooth top end 44d to the tooth bottom 44e. The other tooth surface 44c has a shape in which the tooth bottom side is cut inward from a line symmetric tooth surface of the one tooth surface 44c with respect to a straight line CL2 except for the tooth top end side. Here, the straight line CL2 is a straight line passing from the rotation center of the drum gear 44 (44C shown in FIG. 4) to the top end of the tooth 44a. With respect to the straight line CL2 which is a reference line, a virtual surface (virtual surface shown by a dotted line in FIG. 11) 44f on the opposite side of the one tooth surface 44b is line (plane) symmetrical with the one tooth surface 44b shown by a solid line in FIG. 11. Furthermore, specifically, in this embodiment, the other tooth surface 44c has a shape in which the tooth bottom side is cut off to the straight line CL2 (center in the tooth thickness direction) except for the tooth top end side.

The tooth surface 43b of the transmission gear 43 and the tooth 44a of the drum gear 44 are meshed with each other so that the tooth surface 43b and the tooth surface 44b defined by the involute curves are engaged with each other, so that the driving force is transmitted. In the gear of the comparative example, the non-engagement-side tooth surface not used for meshing also has a tooth surface defined by the involute curve. However, tooth surfaces 43c and 44c on the non-engagement side which are not used for the meshing in this embodiment have cut-away portions that are cut to the extent of the straight lines CL1 and CL2 at the center in the tooth thickness direction in the tooth bottom sides, except for the tooth top end side. By this, the teeth 43a and 44a of this embodiment are less rigid than the teeth of the gear of the comparative example. Therefore, also in this embodiment, as in Embodiment 1, the meshing tooth width can be maybe large even if the load torque is small, and therefore, the meshing ratio can be large, and the range L (FIG. 7) of the acceptable rotation transmission error can be made large.

As described in the foregoing, in this embodiment, the neighborhood of the bottom of the tooth surface on the non-engagement side of the gear has a cut-away portion removed to the extent of the center (straight lines CL1, cL2) in the direction of tooth thickness. By this, even when a cleaner-less portion with a small load torque is employed, and a deviation of about ±30 minutes occurs in the alignment of the gears meshing with each other, the rotation unevenness of the photosensitive drum can be suppressed down to a small value. Therefore, it is possible to provided a image forming apparatus free from image defects such as banding at gear meshing cycles.

In addition, since the width of the tooth top end is the same as that of the gear of the comparative example, it is possible to prevent the tooth top end from being easily damaged by a dent or the like, during transportation of the single component per se or during the assembling work thereof to the apparatus.

### Embodiment 3

In the following, a image forming apparatus provided with a drive transmission device according to Embodiment 3 will be described in detail, referring to the drawings. Here, the schematic structure of the image forming apparatus is the same as that of Embodiment 1 described above, and therefore, the explanation thereof is omitted. In addition, the same members as those of Embodiment 1 are denoted by the same reference numerals, by which the description thereof is omitted. In this embodiment, the gears corresponding to the transmission gear 23 and the drum gear 24 in Embodiment 1 are different only in the shape of the teeth, and the transmission gear 53 and the drum gear 54 will be described with different reference numerals.

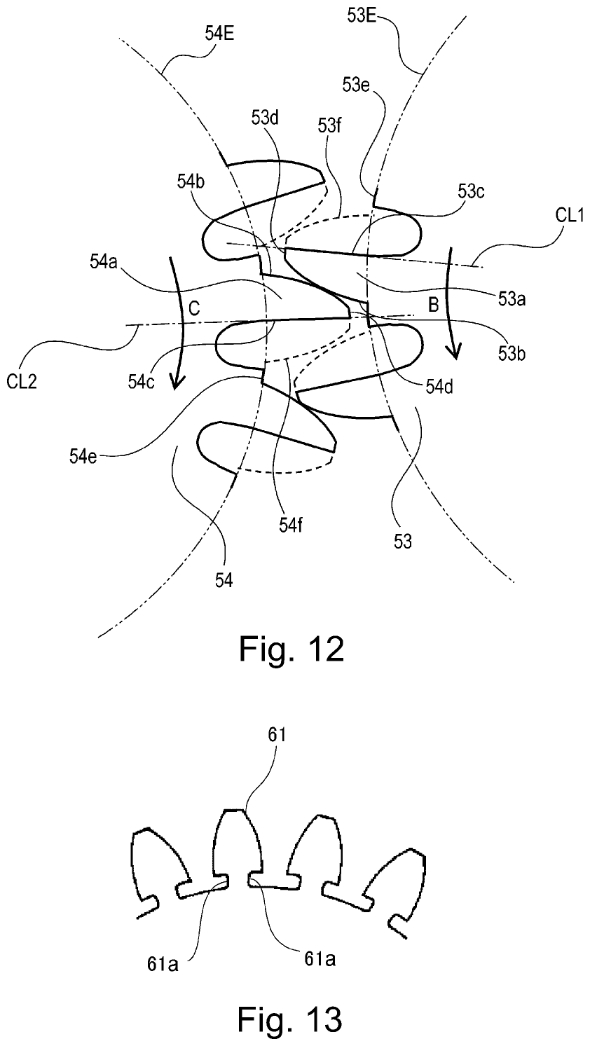

FIG. 12 is a view illustrating the shapes of the transmission gear 53 and the gear of the drum gear 54, in this embodiment. As shown in FIG. 12, each of the teeth 53a of the transmission gear 53, which is the first gear, has one tooth surface 53b on the meshing side and the other tooth surface 53c on the opposite side to the tooth surface 53b, that is, on the non-meshing side. The one tooth surface 53b is formed in the range from the tooth top end 53d to the tooth bottom 53e in the same manner as the tooth surface 33b in Embodiment 1 described above. The other tooth surface 53c is a surface inside a surface (imaginary surface shown by a dotted line in FIG. 12) that is line symmetrical with the one tooth surface 53b with respect to the straight line CL1, and it is a surface along the straight line CL1 from the free end 53d to the root 53e. Here, the other tooth surface 53c has a shape which is cut out to the inner side in the radial direction beyond the root circle 53E. Here, the tooth bottom circle 53E is a circle having a radius from the rotation center of the gear (53C shown in FIG. 4) to the tooth bottom 53e. The radial direction is the direction from the tooth bottom 53e toward the rotational center of the gear (53C shown in FIG. 4).

The tooth 54a of the drum gear 54 which is the second gear meshing with the transmission gear 53 is also formed similarly to the tooth 53a of the transmission gear 53. Each of the teeth 54a of the drum gear 54, which is the second gear, has one tooth surface 54b on the meshing side and the other tooth surface 54c on the opposite side to the tooth surface 54b, that is, on the non-meshing side. The one tooth surface 54b is formed in the same manner as the one tooth surface 34b in Embodiment 1 described above in the range from the tooth top end 54d to the tooth bottom 54e. The other tooth surface 54c is inside of a surface Which is a virtual surface shown by a dotted line in FIG. 12 that is line symmetrical with the one tooth surface 54b with respect to the straight line CL2, and it is a surface extending along the straight line CL2 in the range from 54d to the tooth bottom 54e. And, the other tooth surface 54c has a shape which is cut out to the inner side in the radial direction beyond the root circle 54E. Here, the root circle 54E is a circle having a radius from the rotation center of the gear (54C shown in FIG. 4) to the root 54e. The radial direction is the direction from the tooth bottom 54e toward the rotation center of the gear (54C shown in FIG. 4).

The teeth 53a of the transmission gear 53 and the teeth 54a of the drum gear 54 are engaged with each other at the tooth surface 53b and the tooth surface 54b defined by the involute curves, by which the drive is transmitted. In the gear of the comparative example, the non-engagement-side tooth surface not used for meshing also has a tooth surface defined by the involute curve. However, the tooth surfaces 53c and 54c on the non-meshing side not used for meshing in this embodiment are, as in Embodiment 1, cut from straight lines CL1 and CL2 which are the centers in the tooth thickness direction, in the range from the tooth top end to the tooth bottom. In addition, the non-engaging tooth surfaces 53c and 54c have a shape which is cut out to the inner side, in the gear radial direction, of the tooth bottom circles 53E and 54E. By this, the teeth 53a and 54a of this embodiment are less rigid than the teeth of the gear of the comparative example. Therefore, also in this embodiment, as in Embodiment 1, the meshing tooth width can be made large even if the load torque is small, and therefore, the meshing ratio can be made large, and the acceptable range L (FIG. 7) of the rotation transmission error can be made large.

As described in the foregoing, in this embodiment, a cut-away portion is cut to the extent of the center in the tooth thickness direction, in the range from the free end of the tooth surface on the non-engagement side of the gear to the inner side, in the radial direction, beyond the base circle. By this, even when a cleaner-less portion with a small load torque is employed and a misalignment of about ±30 minutes occurs in the alignment of the gears meshing with each other, the rotation unevenness of the photosensitive drum can be suppressed down to a small value. Therefore, it is possible to obtain a image forming apparatus free from image defects such as banding at gear meshing cycles.

In addition, according to this embodiment, the rigidity of the teeth is weaker than that of Embodiment 1, and therefore, even with a load torque lower than 0.5 kgf·cm, the meshing tooth width can be large. That is, according to this embodiment, even if the load torque is smaller than that of Embodiment 1, the rotation unevenness of the photosensitive drum can be reduced.

### Embodiment 4

In the following, a image forming apparatus provided with a drive transmission device according to Embodiment 4 will be described in detail, referring to the drawings. Here, the same members as those of Embodiment 1 are denoted by the same reference numerals, by which the description thereof is omitted.

This embodiment is different from Embodiment 1 in that it is a color image forming apparatus including four process cartridges 3 and a intermediary transfer belt 70.

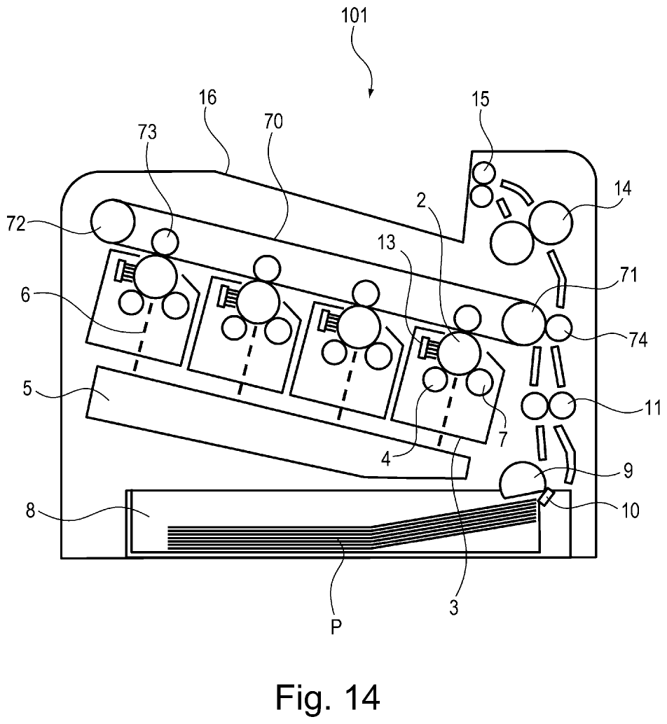

The four process cartridges are provided with yellow, cyan, magenta and black developers (toners) respectively. The respective photosensitive drums 2 are given The driving forces from a end portion on the back side of the image forming apparatus 101 by a drive motor (not shown), and are rotationally driven in the clockwise direction in a FIG. 14. In addition, it is selectively exposed by the laser beam 6 emitted from the laser scanner unit 5 to form an electrostatic latent image. The electrostatic latent image formed on the photosensitive drum 2 is supplied with toner by the developing portion 7 to be developed into a toner image of each color.

The intermediary transfer belt 70 is stretched by a driving roller 71 and a tension roller 72 as a driven roller, and the drive is transmitted from a end portion on the back side of the image forming apparatus 101 by a drive motor (not shown), so that the belt 70 is rotationally driven in the clockwise direction in FIG. 14. By this, the intermediary transfer belt 70 also rotates counterclockwise.

The toner images formed on the four photosensitive drums 2 are sequentially transferred onto the intermediary transfer belt 70 by the four primary transfer rollers 73 facing the photosensitive drum 2 with having a predetermined bias voltage applied thereto, and the transfer of the image is carried on the belt 70.

Here, all toner images on the photosensitive drum 2 are not completely transferred onto the intermediary transfer belt 70, and there is toner remaining on the photosensitive drum 2 as residual toner after the image transfer operation. The residual toner is stirred by a memory removing member 13 formed of a conductive brush or the like and is uniformly dispersed. Thereafter, simultaneously with the toner the positioning operation to the photosensitive drum 2 by the developing portion 7, the residual toner is collected by the developing portion 7 by an electrostatic attraction force. This residual toner removal portion is generally called a cleaner-less portion.

In addition, the fed recording sheet P passes through the registration roller pair 11 and is fed to a transfer position where the intermediary transfer belt 70 and the secondary transfer roller 74 which is a transfer portion in contact with each other. At the secondary transfer position, the toner image on the intermediary transfer belt 70 is transferred onto the recording sheet P by the secondary transfer roller 74 to which a predetermined bias is applied.

The recording sheet P to which the toner image has been transferred is fed to a fixing roller pair 14 of a fixing portion.

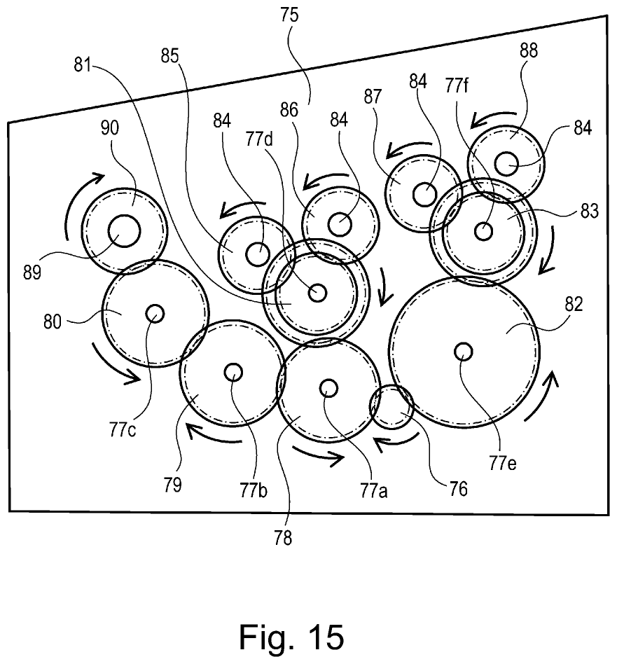

FIG. 15 is a view illustrating the rotational direction of the drive transmission device for rotationally driving the photosensitive drum 2 and the driving roller 71, as viewed from the back side of the image forming apparatus in FIG. 14. The drive motor (not shown) serving as a drive source is fastened to the main assembly rear side plate 75 by a screw (not shown), and a pinion gear 76 is press-fitted and fixed to its output shaft. As in Embodiment 1, the gear shafts 77a to 77f are mounted to the main assembly rear side plate 75 by clamping portions. Transmission gears 78 to 83 are rotatably supported by the gear shafts 77a to 77f. In addition, drum gears 85 to 88 are press-fitted and fixed to a drum shaft 84 that rotates integrally with the photosensitive drum 2. In addition, a driving roller gear 90 is press-fitted and fixed to a drive roller shaft 89 that rotates integrally with the driving roller 71.

The pinion gear 76 rotates in the direction of the arrow in FIG. 15. The driving roller gear 90 is given the driving force from the pinion gear 76 by the transmission gears 78, 79 and 80 to rotate in the direction of the arrow in FIG. 15. The transmission gears 78, 79, 80 and the driving roller gear 90 are a first gear train that transmits drive to the drive roller 91. In addition, the drum gears 85 and 86 are driven by the driving force transmitted from the pinion gear 76 by the transmission gear 81 branched from the transmission gear 78 to rotate in the direction of the arrow in FIG. 15. Furthermore, the drum gears 87 and 88 are driven by the driving force transmitted from the pinion gear 76 by the transmission gears 82 and 83 to rotate in the direction of the arrow in FIG. 15. The transmission gears 82 and 83 and the drum gears 87 and 88 are a second gear train that branches from the first gear train and transmits drive to the photosensitive drum 2. Here, the transmission gears 81 and 83 are step gears including a large gear meshing with the transmission gears 78 and 82 and a small gear smaller in diameter than the large gear which meshes with the drum gears 85, 86 and 87, 88, respectively.

All gears other than the large gear of the transmission gear 81 described above have involute tooth surfaces of a symmetrical shape based on a straight line passing from the rotation center to the free end of the tooth.

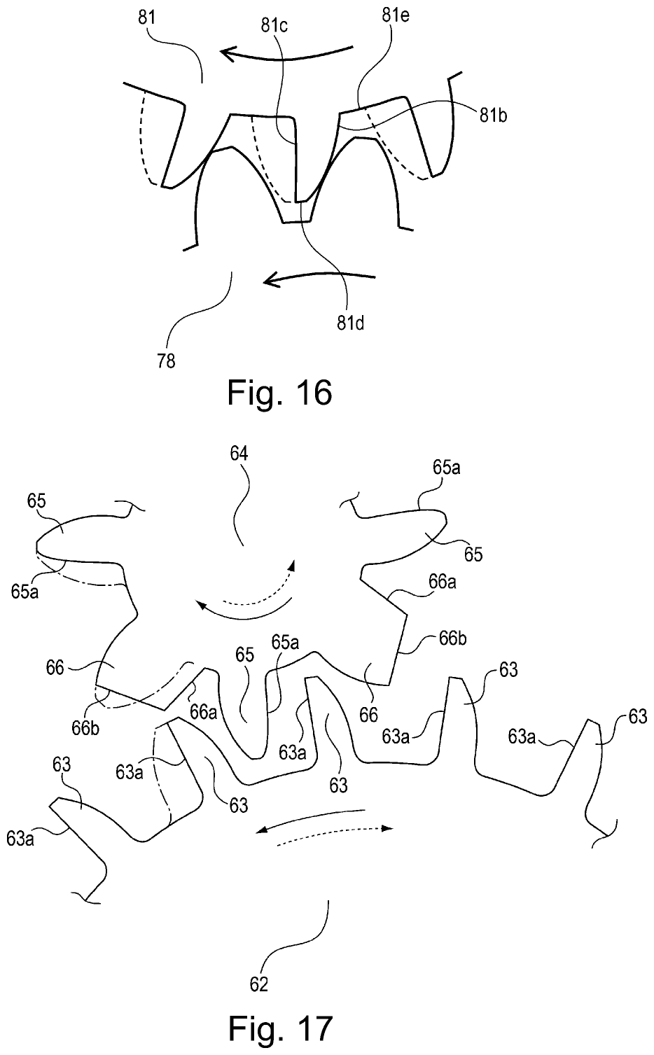

FIG. 16 is for explaining the shape of the large gear of the transmission gear 81. FIG. 16 is a view illustrating the shapes of meshing teeth of the large gear of the transmission gear 81 and the transmission gear 78, which are a pair of gears, at a point where the second gear train branches from the first gear train. Of the pair of gears, the transmission gear 78 before branching is the first gear, and the large gear of the transmission gear 81 after branching is the second gear. A tooth surface 81b on the meshing side is formed along the involute curve from a tooth top end 81d to a tooth bottom 81e, while a tooth surface 81c on the non-meshing side is cut away in the same manner as the tooth surface 24c of Embodiment 1.

In this embodiment, as described above, the cleaner-less portion is employed, and therefore, when the photosensitive drum 2 rotates, its friction resistance is light, and its load torque is as light as about 0.5 kgf·cm. On the other hand, the load torque of the driving roller 71 rotates the intermediary transfer belt 70 biased by the tension roller 72, and therefore, it is as heavy as about 4 kgf·cm. Therefore, the transmission gears 78 to 80 for driving the driving roller 71 have a heavy load torque, and have a certain degree of inclination due to the inclination of the gear shafts 77a to 77c and due to the deformation of the gears themselves. On the other hand, the transmission gear 81 for driving the photosensitive drum 2 has a light load torque, and therefore, its inclination is smaller than that of the transmission gears 78-80. Therefore, in the meshing portion of the transmission gear 78 and the large gear of the transmission gear 81, the misalignment is larger than that of the meshing portion of the other drum drive train. That is, in the drum drive train with the light load torque, the meshing portion between the transmission gear 78 and the large gear of the transmission gear 81 is the most disadvantageous portion, from the stand point of the rotation transmission error. In this embodiment, the teeth of the most disadvantageous meshing portion are provided with the cut-away portion shown in FIG. 16. In this embodiment, the meshing tooth width can be made large even if the load torque is light, and therefore, it is possible to provided a image forming apparatus which can keep the rotation transmission error within an acceptable range and can greatly improve the image defects such as banding at the gear meshing cycle.

In addition, in this embodiment, although the cut-away portion is provided on the non-engagement side tooth surface of the large gear of the transmission gear 81, the present invention is not limited to this. For example, even if the transmission gear 81 is made of a material such as a polyester-based elastomer softer than polyacetal (POM), the teeth can be easily bent, so that the meshing tooth width can be increased and the same effect can be provided. In this case, it is possible to make only one gear from a material more expensive than polyacetal (POM), and therefore, the cost increase can be limited.

In addition to the above, even if the large gear of the transmission gear 81 is crowned, the reduction in meshing tooth width when the gear is inclined can be alleviated, and therefore, the same effect is provided. In this case, it is possible to make only one crowning gear, and therefore, the cost increase can be limited. Here, the gear crowning is tooth shape modification in the gear flank direction of the gear teeth. For example, in gear manufacturing in which the gear teeth are appropriately bulged, so as to concentrate the tooth contact area on the central portion of the tooth width.

### OTHER EMBODIMENTS

In Embodiments 1 to 3 described above, the first gears as a plurality of gears of the drive transmission device and the second gears meshed with the first gears are cut-away portion on the tooth surface at the non-meshing side. However, the present invention is not limited to this. A structure in which a cut-away portion is provided on any one non-engagement side tooth surface in a meshing relationship may be employed. With such a structure as well, it is possible to reduce the uneven rotation of the rotatable member to which the drive is transmitted through the plurality of gears, as in the above-described embodiment. According to this structure, the acceptable range L of the deviation between the meshing gears is slightly smaller than the range L of the embodiment shown in FIG. 7, but is still larger than the range K of the comparative example shown in FIG. 6.

In addition, in Examples 1 to 3 described above, a image forming apparatus in which one process cartridge can be mounted and dismounted is illustrated, but the number of cartridges used is not limited and can be selected as required. For example, in a, color image forming apparatus, four process cartridges can be mounted and dismounted.

In addition, in the embodiments described above, the process cartridge including the photosensitive drum, the charging means as the process means acting on the photosensitive drum, and the developing means integrally has been exemplified as the process cartridge dismountable from the image forming apparatus. However, the present invention is not limited to such. It may be a process cartridge integrally including any one of a charging portion and a developing portion, in addition to the photosensitive drum.

Furthermore, in the embodiments described above, the process cartridge including the photosensitive drum is illustrated as being dismountable from the image forming apparatus, but the invention is not limited thereto. For example, it may be a image forming apparatus in which each component is incorporated, or a image forming apparatus in which each component is dismountable.

In addition, in the embodiments described above, the structure in which the toner remaining on the photosensitive drum after the image transfer is collected by the developing portion has been exemplified, but the present invention is not limited to this structure. Instead of the structure in which the developing portion functions also as the cleaning portion, a structure in which a cleaning portion for removing the toner remaining on the photosensitive drum with a cleaning blade or the like may be separately provided.

In addition, although the printer is exemplified as the image forming apparatus in the embodiment described above, the present invention is not limited to such. For example, it may be another image forming apparatus such as a copying machine or a facsimile machine, or another image forming apparatus such as a multi-function machine combining these functions. In addition, in Embodiment 4 described above, the image forming apparatus has been exemplified, in which the toner images of the respective colors are sequentially superimposed and transferred onto the intermediary transfer belt, and the toner images carried by the intermediary transfer belt are collectively transferred onto the recording material. However, the present invention is not limited to such a structure. The image forming apparatus may be such that the toner images of the photosensitive members of the respective colors are sequentially superimposed and transferred onto the recording material attracted and fed on the transfer conveyance belt. The same effect can be provided by applying the present invention to a drive transmission device usable with these image forming apparatuses.

According to the present invention, the rotation unevenness of the rotatable member can be reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2018-103586 filed on May 30, 2018 and 2019-000427 filed on Jan. 7, 2019, which are hereby incorporated by reference herein in their entirety.

What is claimed is:

1. A drive transmission device for transmitting a driving force to a rotatable member, said device comprising:
a first gear and;
a second gear in meshing engagement with the first gear;
wherein each tooth of said first gear includes, between a tooth top and a tooth bottom, one tooth surface and the other tooth surface on an opposite side of said one tooth surface, and each tooth of said second gear includes, between a tooth top of said second gear and a tooth bottom of said second gear, one tooth surface and the other tooth surface of said second gear on an opposite side of said one tooth surface of said second gear,
wherein said one surface of said first gear engages to said one surface of said second gear, and the other surface of said first gear is not engaged to the other surface of said second gear,
wherein said one tooth surfaces extend along respective involute curves, and
wherein for at least one of said first gear and said second gear, the other tooth surface extends from a tooth top side to a tooth bottom side along a linear line inside a plane which is symmetrical with said one tooth surface with respect to a line connecting the tooth top and the tooth bottom.

2. A drive transmission device for transmitting a driving force to a rotatable member, said device comprising:
a first gear; and
a second gear in meshing engagement with the first gear;
wherein each tooth of said first gear includes, between a tooth top and a tooth bottom, one tooth surface and the other tooth surface on an opposite side of said one tooth surface, and each tooth of said second gear includes, between a tooth top of said second gear and a tooth bottom of said second gear, one tooth surface and the other tooth surface of said second gear on an opposite side of said one tooth surface of said second gear, and
wherein said one surface of said first gear engages to said one surface of said second gear, and the other surface of said first gear is not engaged to the other surface of said second gear,
wherein said one tooth surfaces extend along respective involute curves, and wherein for at least one of said first gear and said second gear, the other tooth surface has a shape cut away, except for a tooth top side, from a plane which is symmetrical with said one tooth surface with respect to a line connecting the tooth top and the tooth bottom.

3. A device according to claim 2, wherein the other tooth surface is cut away to the line in the tooth bottom side.

4. A device according to claim 1, wherein the other tooth surface is cut away in a radial direction beyond a deddendum circle.

5. A device according to claim 1, wherein said first gear and said second gear are made of polyacetal.

6. A device according to claim 1, wherein said rotatable member is a photosensitive member having a photosensitive layer and which an electrostatic latent image is capable of being formed by image exposure.

7. An image forming apparatus for forming a image on the recording material comprising: a photosensitive member, an exposing portion configured to expose said photosensitive member to image light, a developing portion configured to develop an electrostatic latent image formed on said photosensitive member by said exposing portion, a transfer portion configured to transfer the toner image onto the recording material, a cleaning portion configured to remove the toner remaining on said photosensitive member after the image transfer by said transfer portion, a fixing portion configured to fix the toner image on the recording material, and said drive transmission device according to claim 1 to transfer the driving force to said photosensitive member.

8. An image forming apparatus for forming a image on the recording material comprising: a photosensitive member, an exposing portion configured to expose said photosensitive member to image light, a developing portion configured to develop an electrostatic latent image formed on said photosensitive member by said exposing portion, a transfer portion configured to transfer the toner image onto the recording material, a cleaning portion configured to remove the toner remaining on said photosensitive member after the image transfer by said transfer portion, a fixing portion configured to fix the toner image on the recording material,
wherein said developing portion is configured to collect the toner remaining on said photosensitive member after image transfer by said transferring portion,
said apparatus further comprises said drive transmission device according to claim 1 to transfer the driving force to said photosensitive drum.

9. An apparatus according to claim 8, further comprising a post-transfer exposing portion configured to irradiate the toner remaining on said photosensitive member after the image transfer.

10. An apparatus according to claim 8, wherein the toner remaining on said photosensitive member of the image transfer is collected without a cleaning blade removing the toner in contact said photosensitive member.

11. An image forming apparatus for forming a image on a recording material comprising: a image forming apparatus for forming a image on the recording material comprising: a photosensitive member, an exposing portion configured to expose said photosensitive member to image light, a developing portion configured to develop an electrostatic latent image formed on said photosensitive member by said exposing portion, a transfer portion configured to transfer the toner image onto the recording material, a cleaning portion configured to remove the toner remaining on said photosensitive member after the image transfer by said transfer portion, a fixing portion configured to fix the toner image on the recording material, and a belt stretched around a driving roller and at least one follower roller, a first gear train configured to transmit a driving force to said driving roller and a second gear train branched out of said first gear train transmit a driving force to said photosensitive member, and
wherein a gear pair provided at a position where said second gear train branched out of said first gear train comprises said drive transmission device according to claim 1, wherein said first gear is provided before branching, and said second gear is provided after the branching.

12. An image forming apparatus for forming a image on a recording material comprising: a image forming apparatus for forming a image on the recording material comprising: a photosensitive member, an exposing portion configured to expose said photosensitive member to image light, a developing portion configured to develop an electrostatic latent image formed on said photosensitive member by said exposing portion, a transfer portion configured to transfer the toner image onto the recording material, a cleaning portion configured to remove the toner remaining on said photosensitive member after the image transfer by said transfer portion, a fixing portion configured to fix the toner image on the recording material, and a belt stretched around a driving roller and at least one follower roller, a first gear train configured to transmit a driving force to said driving roller and a second gear train branched out of said first gear train transmit a driving force to said photosensitive member, and
wherein at least one of gears of a gear pair provided at a position where said second gear train branched out of said first gear train comprises a material softer than that of a gear provided on a rotational shaft said driving roller.

13. An image forming apparatus for forming a image on a recording material comprising: a image forming apparatus for forming a image on the recording material comprising: a photosensitive member, an exposing portion configured to expose said photosensitive member to image light, a developing portion configured to develop an electrostatic latent image formed on said photosensitive member by said exposing portion, a transfer portion configured to transfer the toner image onto the recording material, a cleaning portion configured to remove the toner remaining on said photosensitive member after the image transfer by said transfer portion, a fixing portion configured to fix the toner image on the recording material, and a belt stretched around a driving roller and at least one follower roller, a first gear train configured to transmit a driving force to said driving roller and a second gear train branched out of said first gear train transmit a driving force to said photosensitive member, and
wherein at least one of gears of a gear pair provided at a position where said second gear train branched out of said first gear train is crowned at at least one gear tooth thereof.

14. An apparatus according to claim 11, wherein said belt an intermediary transfer belt configured to sequentially receive the toner image from said photosensitive member.

15. An apparatus according to claim 11, wherein said belt is a transfer feeding belt configured to attract the recording material which receives the toner image from said photosensitive member.

16. An apparatus according to claim 11, wherein said developing portion is configured to collect the toner remaining on said photosensitive member and the image transfer.

17. An apparatus according to claim 16, further comprising a post-transfer exposing portion configured to irradiate the toner remaining on said photosensitive member after the image transfer.
